(19) United States
(12) Patent Application Publication
(10) Pub. No.: US 2017/0041039 A1
(43) Pub. Date: Feb. 9, 2017

(54) ANALOG INTERFERENCE CANCELLATION USING DIGITAL COMPUTATION OF CANCELLATION COEFFICIENTS

(71) Applicant: QUALCOMM Incorporated, San Diego, CA (US)

(72) Inventors: Insoo HWANG, San Diego, CA (US); Joonhoi Hur, San Diego, CA (US); Won-ick Lee, San Diego, CA (US)

(21) Appl. No.: 14/819,197

(22) Filed: Aug. 5, 2015

(51) Int. Cl. H04B 1/48

(52) U.S. Cl. CPC H04B 1/48; H04B 2001/485

(57) ABSTRACT

Various aspects described herein relate to providing analog interference cancellation using digitally computed coefficients. An aggressor signal can be obtained from a transmitter chain of a radio frequency (RF) front end. A digital representation of the aggressor signal can be generated, and cancellation coefficients can be estimated for the digital representation of the aggressor signal. An analog cancellation signal can be generated based at least in part the cancellation coefficients and the digital representation of the aggressor signal. The analog cancellation signal can be added to a victim signal in a receiver chain of the RF front end to cancel interference to the victim signal from the aggressor signal.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency divisional multiple access (SC-FDMA) systems, time division synchronous code division multiple access (TD-SCDMA) systems, and Long Term Evolution (LTE), which is a set of enhancements to the Universal Mobile Telecommunications System (UMTS) mobile standard promulgated by Third Generation Partnership Project (3GPP).

These multiple access technologies have been adopted in various telecommunication standards to provide a common protocol that enables different wireless devices to communicate on a municipal, national, regional, and even global level. Generally, a wireless multiple-access communication system can simultaneously support communication for multiple wireless terminals (e.g., user equipment (UE)), each of which can communicate with one or more base stations over downlink or uplink resources.

In some LTE (or other wireless communication technology) configurations, user equipment (UE) can be provided with multiple antennas to concurrently transmit and/or receive communications with a base station. Due to close proximity of the antennas and related radio frequency (RF) resources within the UE, transmission from the UE may interfere with reception at the UE. Accordingly, the UEs can utilize some mechanisms to cancel the interference at the receiver. Some previous attempts to cancel the interference include using a feedback receiver to receive and digitally cancel transmissions from a transmit antenna of the UE. Feedback receivers, however, cannot prevent front-end saturation due to operation solely in the digital domain. Other attempts to cancel the interference include the use of a diversity antenna to perform analog cancellation. This configuration, however, does not allow for fine control of cancellation coefficients.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

According to an example, a method for providing analog interference cancellation using digitally computed coefficients is provided. The method includes obtaining an aggressor signal from a transmitter chain of a radio frequency (RF) front end, generating a digital representation of the aggressor signal, estimating, by a processor, cancellation coefficients for the digital representation of the aggressor signal, generating an analog cancellation signal based at least in part the cancellation coefficients and the digital representation of the aggressor signal, and adding the analog cancellation signal to a victim signal in a receiver chain of the RF front end to cancel interference to the victim signal from the aggressor signal.

In another example, an apparatus for providing analog interference cancellation using digitally computed coefficients is provided. The user equipment includes a transmitter antenna coupled to one or more components of a transmitter chain of a RF front end configured to transmit an aggressor signal, a receiver antenna coupled to one or more components of a receiver chain of the RF front end configured to receive a victim signal and the aggressor signal, and at least one processor communicatively coupled with the transmitter chain and the receiver chain and having a cancellation signal generator. The cancellation signal generator is executable by the at least one processor to obtain the aggressor signal from the transmitter chain of the RF front end, generate a digital representation of the aggressor signal, and estimate cancellation coefficients for the digital representation of the aggressor signal. The user equipment also includes a digital-to-analog converter (DAC) configured to generate an analog cancellation signal based at least in part the cancellation coefficients and the digital representation of the aggressor signal, and a summer configured to add the analog cancellation signal received from the DAC to the victim signal in the receiver chain of the RF front end to cancel interference to the victim signal from the aggressor signal.

In a further example, an apparatus for providing analog interference cancellation using digitally computed coefficients is provided. The user equipment includes means for obtaining an aggressor signal from a transmitter chain of a RF front end, means for generating a digital representation of the aggressor signal, means for estimating cancellation coefficients for the digital representation of the aggressor signal, means for generating an analog cancellation signal based at least in part the cancellation coefficients and the digital representation of the aggressor signal, and means for adding the analog cancellation signal to a victim signal in a receiver chain of the RF front end to cancel interference to the victim signal from the aggressor signal.

Moreover, in an example, a computer-readable medium comprising code executable by a computer for providing analog interference cancellation using digitally computed coefficients is provided. The code includes code for obtaining an aggressor signal from a transmitter chain of a RF front end, code for generating a digital representation of the aggressor signal, code for estimating cancellation coefficients for the digital representation of the aggressor signal, code for generating an analog cancellation signal based at least in part the cancellation coefficients and the digital representation of the aggressor signal, and code for adding the analog cancellation signal to a victim signal in a receiver chain of the RF front end to cancel interference to the victim signal from the aggressor signal.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The accompanying drawings are presented to aid in the description of various aspects of the disclosure and are provided solely for illustration of the aspects and not limitation thereof. The drawings include like reference numbers for like elements, and may represent optional components or actions using dashed lines.

FIGS. 1 and 2 are block diagrams illustrating example wireless communications systems including a user equipment having an RF front end and one or more processors configured to perform analog interference cancellation using digitally computed cancellation coefficients, according to aspects described herein.

FIGS. 3 and 4 depict a flow diagram of an example method for generating and injecting a cancellation signal in accordance with aspects described herein.

FIG. 5 is a block diagram conceptually illustrating an example band-pass sigma-delta filter in accordance with aspects described herein.

FIG. 6 is a block diagram conceptually illustrating an example pulse width modulator in accordance with aspects described herein.

FIG. 7 is a block diagram conceptually illustrating an example band-pass sigma-delta filter and pulse width modulator in accordance with aspects described herein.

FIG. 8 is a block diagram conceptually illustrating an example digital polar digital-to-analog converter (DAC) in accordance with aspects described herein.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known components are shown in block diagram form in order to avoid obscuring such concepts. Also, the terms “component” or “generator” as used herein may be one of the parts that make up a system, may be hardware, firmware, and/or software, and may be divided into other functions.

Described herein are various aspects related to performing analog interference cancellation by one or more processors of a device capable of wireless communications using digitally computed cancellation coefficients. For example, one or more components of the device may obtain a signal (e.g., an aggressor signal) from a transmitter chain that is potentially causing interference to a receiver chain in a radio frequency (RF) front end of the device. The one or more components, which may be executed by the one or more processors of the device, can generate a digital representation of the aggressor signal, for example, using an auxiliary receiver to receive the signal and an analog-to-digital converter (ADC) to generate the digital representation, or otherwise based on digitally reconstructing distortion of the aggressor signal based at least in part on outputs of one or more components of the transmitter chain (e.g., a mixer, a distributed amplifier (DA), a power amplifier (PA), a transmit (Tx) filter, etc.). Further, the one or more components can compute cancellation coefficients for the digital representation of the aggressor signal and mix the cancellation coefficients with the digital representation of the aggressor signal. The one or more components can then use the mixed combination of the cancellation coefficients and digital representation of the aggressor signal to generate a digital cancellation signal. A digital-to-analog converter (DAC) can convert the digital cancellation signal to an analog cancellation signal, and can provide the digital cancellation signal for injecting (e.g., adding) into the receiver chain to cancel interference caused by the aggressor signal.

In one example, the DAC may include an RF DAC to generate the analog cancellation signal from the cancellation coefficients and the digital representation of the aggressor signal. Using an RF DAC in this manner allows for direct conversion of the cancellation signal from digital to analog without requiring mixers or additional amplifiers. In addition, a digital clock of the RF DAC can be fixed to cover a wide range of frequency carriers (e.g., a plurality of different carrier signals each transmitted at a different frequency). Though generally described herein as a user equipment (UE) communicating in a wireless network, it is to be appreciated that the device may be one or more of, or a portion of, a UE, relay node, small cell, evolved Node B (eNB), radio frequency identifier (RFID) device, near field communication (NFC) device, or other device capable of performing wireless communications with another peer or different device.

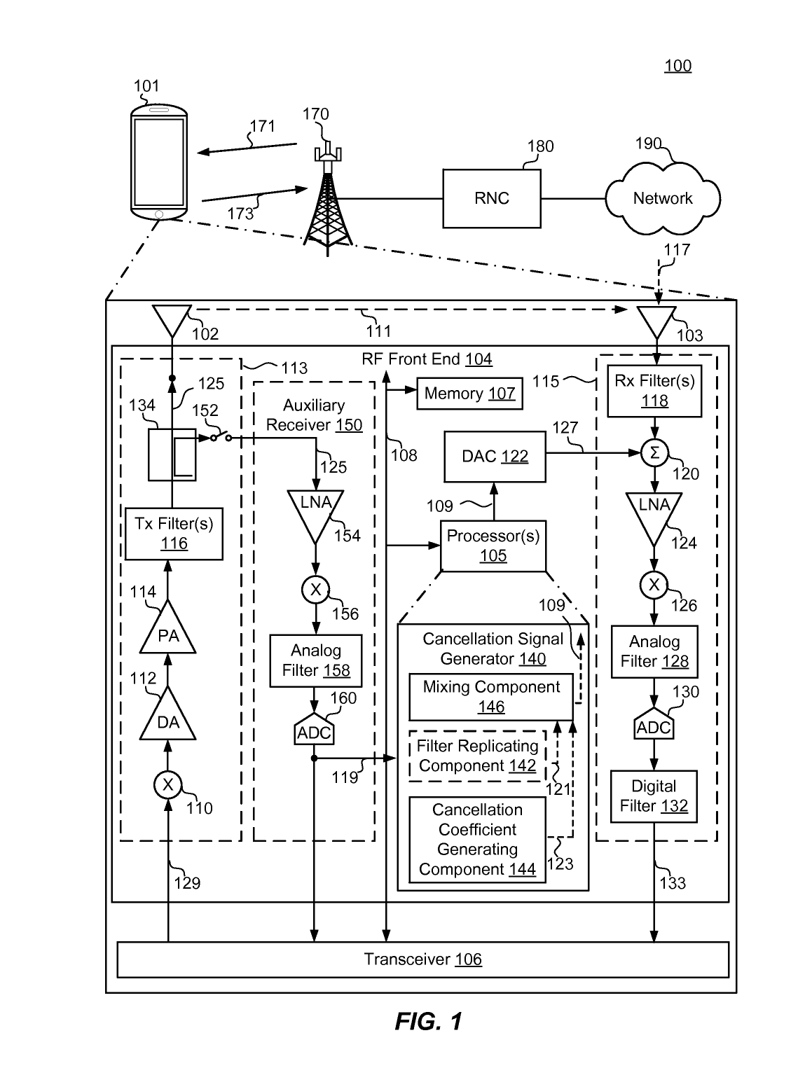

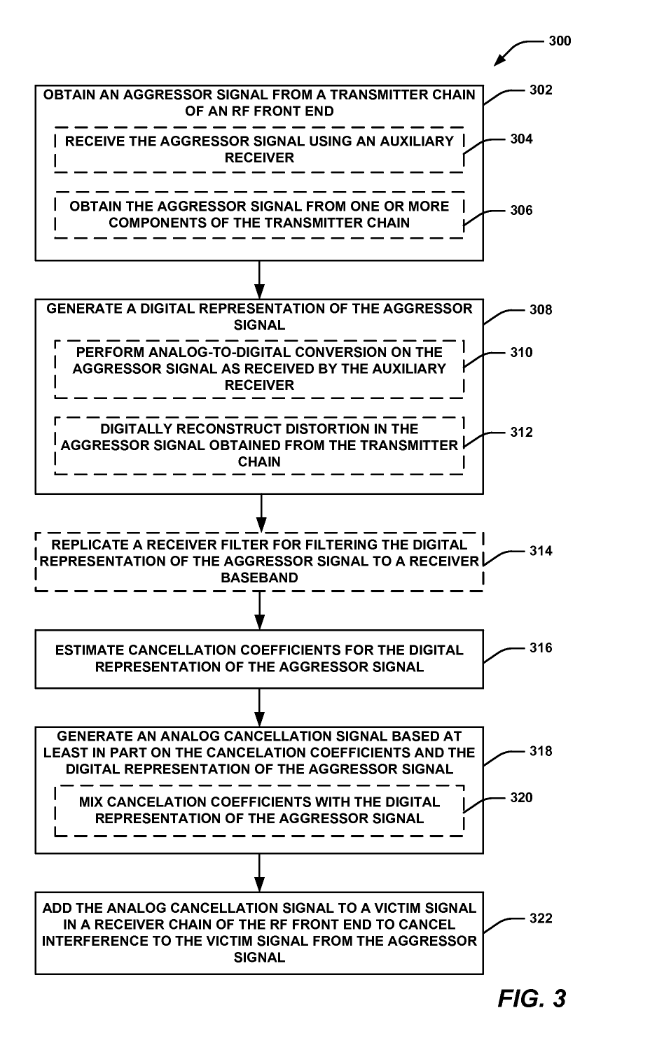

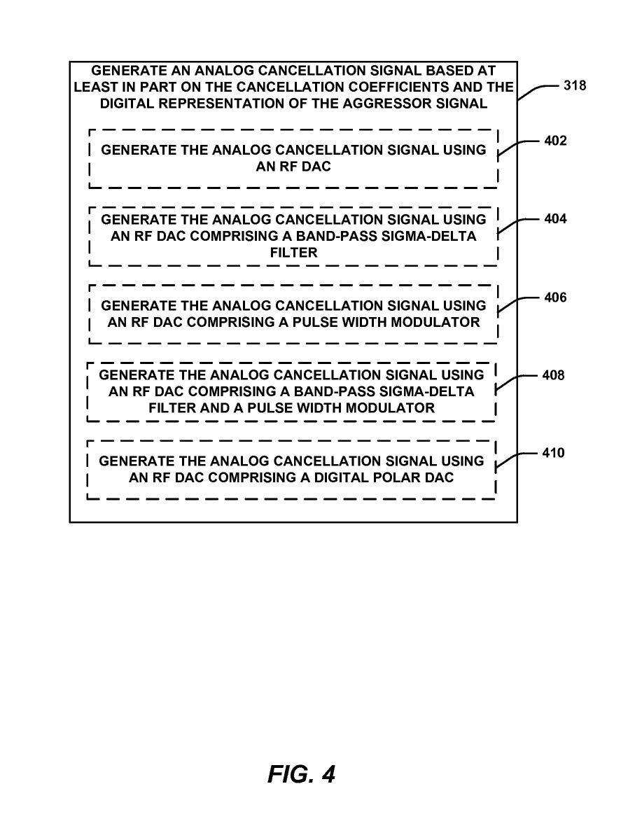

Referring to FIGS. 1-8, aspects are depicted with reference to one or more components, etc., and one or more methods that may perform the actions described herein. Although the operations described below in FIGS. 3 and 4 are presented in a particular order and/or as being performed by an example component, etc., it should be understood that the ordering of the actions and the components performing the actions may be varied, depending on the implementation. Moreover, it should be understood that the following actions may be performed by a specially-programmed processor, a processor executing specially-programmed software or computer-readable media, or by any other combination of a specially-programmed or configured hardware component and/or a specially-programmed or configured software component capable of performing the described actions.

FIG. 1 illustrates a wireless communication system 100 including a UE 101 in communication coverage of a network entity 170 (e.g., a base station or node B (NodeB or NB) providing one or more cells). UE 101 can communicate with a network 190 via network entity 170 and/or a radio network control (RNC) 180. In an aspect, UE 101 may have established one or more uplink channels 173 for sending control and/or data transmissions (e.g., signaling) to network entity 170, and one or more downlink channels 171 for receiving control and/or data messages (e.g., signaling) via network entity 170 over configured communication resources (e.g., time and/or frequency resources).

In an aspect, UE 101 may include one or more processors 105 and/or a memory 107 that may be communicatively coupled, e.g., via one or more buses 108 (e.g., along with one or more other components of UE 101), and may operate in conjunction with or otherwise implement a cancellation signal generator 140 and a digital-to-analog converter (DAC) 122 for generating an analog cancellation signal 127 to provide analog interference cancellation for a receiver antenna 103 of UE 101, as described herein. For example, cancellation signal generator 140 may execute various components, or operate in conjunction with various components, for generating a digital cancellation signal 109 based on a digital representation 119 of aggressor signal 125 to be transmitted by transmitter antenna 102 as transmitted aggressor signal 111. For example, the transmitted aggressor signal 111 may interfere with one or more victim signals 117 received at receiver antenna 103, where aggressor signal 125 is received by the auxiliary receiver 150. Accordingly, in an example, the digital cancellation signal 109 can be provided to a DAC 122 for converting to analog cancellation signal 127 and injecting into the receiver chain 115 of the RF front end 104 to cancel interference of the transmitted aggressor signal 111 from the victim signal 117 received by receiver antenna 103.

In an aspect, for example, transmitted aggressor signal 111 may be any signal transmitted by antenna 102 or generated for transmission by one or more components of transmitter chain 113. Further, in an aspect, for example, victim signal 117 may be any over-the-air signal received concurrently with transmitted aggressor signal 111 by antenna 103 and communicated to receiver chain 115, where the ability of UE 101 to decode victim signal 117 may be affected due to interference from also receiving transmitted aggressor signal 111. The various specially configured actions related to cancellation signal generator 140 may be implemented or otherwise executed by one or more processors 105 and, in an aspect, can be executed by a single processor, while in other aspects, different ones of the functions may be executed by a combination of two or more different processors. For example, in an aspect, the one or more processors 105 may include any one or any combination of a modem processor, a baseband processor, a digital signal processor, a field-programmable gate array (FPGA), an application specific integrated circuit (ASIC), a transmit processor, a transceiver processor associated with transceiver 106, etc. Further, for example, the memory 107 may be a non-transitory computer-readable medium that includes, but is not limited to, random access memory (RAM), read only memory (ROM), programmable ROM (PROM), erasable PROM (EPROM), electrically erasable PROM (EEPROM), a magnetic storage device (e.g., hard disk, floppy disk, magnetic strip), an optical disk (e.g., compact disk (CD), digital versatile disk (DVD)), a smart card, a flash memory device (e.g., card, stick, key drive), a register, a removable disk, and any other suitable medium for storing software and/or computer-readable code or instructions that may be accessed and read by a computer or one or more processors 105. Moreover, memory 107 or computer-readable storage medium may be resident in the one or more processors 105, external to the one or more processors 105, or distributed across multiple entities including the one or more processors 105.

In particular, the one or more processors 105 and/or memory 107 may execute actions described herein with respect to cancellation signal generator 140 or its subcomponents. For instance, the one or more processors 105 and/or memory 107 may execute actions or operations defined by an optional filter replicating component 142 for replicating one or more receiver filters in the receiver chain 115, such as receiver (Rx) filter 118, to apply to digital representation 119 of aggressor signal 125 as received by auxiliary receiver 150 to generate filtered digital representation 121. In an aspect, for example, filter replicating component 142 may include hardware (e.g., one or more processor modules of the one or more processors 105) and/or computer-readable code or instructions stored in memory 107 and executable by at least one of the one or more processors 105 to perform the specially configured filter replicating operations described herein. Further, for instance, the one or more processors 105 and/or memory 107 may execute actions or operations defined by a cancellation coefficient generating component 144 for generating one or more cancellation coefficients 123 corresponding to digital representation 119 of aggressor signal 125. In an aspect, for example, cancellation coefficient generating component 144 may include hardware (e.g., one or more processor modules of the one or more processors 105) and/or computer-readable code or instructions stored in memory 107 and executable by at least one of the one or more processors 105 to perform the specially configured cancellation coefficient generating operations described herein. Further, for instance, the one or more processors 105 and/or memory 107 may execute actions or operations defined by a mixing component 146 for mixing the digital representation 119 of aggressor signal 125 as received by auxiliary receiver 150 and the cancellation coefficients to generate digital cancellation signal 109. In an aspect, for example, mixing component 146 may include hardware (e.g., one or more processor modules of the one or more processors 105) and/or computer-readable code or instructions stored in memory 107 and executable by at least one of the one or more processors 105 to perform the specially configured mixing operations described herein. Further in an example, digital cancellation signal 109 may have a form to cancel the received transmitted aggressor signal 111, and a DAC 122 may convert the digital cancellation signal 109 to analog cancellation signal 127 for providing analog interference cancellation of transmitted aggressor signal 111.

Moreover, in an aspect, UE 101 may include RF front end 104 and transceiver 106 for receiving and transmitting radio signals. For example, transceiver 106 may communicate with the one or more processors 105 or other processors (not shown) to obtain signals for transmitting via RF front end 104 and/or to provide signals received via RF front end 104 for processing. RF front end 104 may be connected to one or more antennas, which may include at least a transmitter antenna 102 and a receiver antenna 103 (though additional transmitter and/or receiver antennas can be provided in UE 101). RF front end 104 may include various components of transmitter chain 113 connected to transmitter antenna 102 and receiver chain 115 connected to receiver antenna 103. For example, the transmitter chain 113 may include one or more of a mixer 110, DA 112, PA 114, Tx filter(s) 116, etc., to generate a transmit signals, which may include aggressor signal 125, for transmitting (e.g., over uplink channel 173) via transmitter antenna 102. The receiver chain 115, in an example, may include one or more of a Rx filter(s) 118, a summer 120 to add analog cancellation signal 127 to a received signal in some examples (such as victim signal 117), a low-noise amplifier (LNA) 124, a mixer 126, an analog filter 128, an ADC 130, and a digital filter 132 to facilitate receiving (e.g., over downlink channel 171) signals, which may include victim signal 117 or signals from network entity 170, in wireless communications. As described further herein, Rx filter 118 can filter the received signals to a baseband of the receiver chain 115. The “baseband” can correspond to a frequency band over which the receiver chain 115 is to receive signals, and the Rx filter 118 can filter received victim signals 117 at the frequency band. In an example, summer 120 can add an analog cancellation signal 127 from DAC 122 to the received victim signal 117 to generate a received signal with a transmitted aggressor signal 111 cancelled therefrom. LNA 124, mixer 126, analog filter 128, ADC 130, and digital filter 132 can be applied to the signal to produce a digital received signal 133 for providing to transceiver for processing at higher network layers.

In an example, transmitter antenna 102 can transmit signals while receiver antenna 103 is concurrently and/or simultaneously receiving signals (e.g., over a same or different frequency band, which may overlap in frequency), such that signals transmitted over transmitter antenna 102 may cause interference to signals received over receiver antenna 103. In this regard, cancellation signal generator 140 in combination with DAC 122 can generate an analog cancellation signal 127 based on signals (e.g., transmitted aggressor signal 111) being transmitted over transmitter antenna 102 for adding into the receiver chain 115 to cancel interference caused to other received signals (e.g., victim signal 117) that are being concurrently received by receiver antenna 103.

In the depicted example, RF front end 104 may also optionally include an auxiliary receiver 150, which may typically be used to receive signals for other applications at UE 101, and thus may be operated by a switch 152 for utilizing in processing signals for cancellation as described herein. Auxiliary receiver 150 may be used for receiving one or more signals or transmissions from the transmitter chain 113 (e.g., aggressor signal 125 at Tx filter 116 output that is transmitted by antenna 102 as transmitted aggressor signal 111) for providing to the cancellation signal generator 140 for use in generating a related digital cancellation signal 109, which can be converted into analog cancellation signal 127. Auxiliary receiver 150 may receive the one or more aggressor signals 125, to be transmitted by antenna 102 as transmitted aggressor signal 111, from a directional coupler 134 or other output of Tx filter 116 for use in cancelling potential interference to one or more victim signals 117 by transmitted aggressor signal 111 received by antenna 103 and receiver chain 115. In this regard, in an example, the switch 152 may be selectively operated (as opposed to being continuously operated) based on when and/or whether receiver antenna 103 and/or components of the receiver chain 115 are operable for receiving signals (e.g., over downlink channel 171). In this example, switch 152 can be switched on to activate the auxiliary receiver 150 for receiving signals to be cancelled when the receiver antenna 103 and/or components of the receiver chain 115 are receiving signals, and can be switched off to deactivate the auxiliary receiver 150 for receiving signals to be cancelled (e.g., and/or to reactivate the auxiliary receiver 150 for another application) when the receiver antenna 103 and/or components of the receiver chain 115 are not receiving signals (and thus interference is not a concern). This selective operation of switch 152 can allow use of the auxiliary receiver 150, though it may be used for other applications in the UE 101.

In any case, auxiliary receiver 150 may include a LNA 154, mixer 156, analog filter 158, and ADC 160, where each of these components may be similar to the corresponding components of receiver chain 115 for receiver antenna 103 described above. Thus, auxiliary receiver 150 receives the signal to be transmitted (e.g., aggressor signal 125) via transmitter antenna 102, performs operations on the signal via LNA 154, mixer 156, and analog filter 158, as described below with respect to LNA 124, mixer 126, analog filter 128, etc., and converts the signal to digital representation 119 of the aggressor signal 125 (as received by auxiliary receiver 150) via ADC 160. ADC 160 provides the digital representation 119 of the signal to the cancellation signal generator 140 for generating a corresponding digital cancellation signal 109. In this regard, the digital representation 119 of the aggressor signal 125 provided to cancellation signal generator 140 may include some characteristics of transmitted aggressor signal 111 transmitted via transmitter antenna 102, such as distortion that may be caused by other interference to the various components (e.g., mixer 110, DA 112, PA 114, Tx filter 116, etc.) of the transmitter chain 113 (e.g., due to signal leakage) that modify aggressor signal 125 and/or the transmitted aggressor signal 111. As such, providing digital representation 119 by auxiliary receiver 150 allows for providing a more accurate representation of the received transmitted aggressor signal 111 than by obtaining the aggressor signal 129 as initially provided to the transmitter chain 113 as input from transceiver 106. In one example, it is to be appreciated that the auxiliary receiver 150 and/or components thereof may be part of an unused RF chain (e.g., receiver chain 115 and/or transmitter chain 113) of another antenna (not shown) at the UE 101.

Moreover, it is to be appreciated, for example, that components of RF front end 104 can connect with transceiver 106 (e.g., LNAs 124, PAs 114, DA 112, mixers 110, 126, filters 116, 118, 128, 132, ADC 130, etc.) for providing to additional components of the UE 101 (e.g., one or more additional processors for processing related communications at higher network communication layers, etc.). RF front end 104 can support communications over multiple bands via the multiple filters 116 and/or 118, LNAs 124, and/or PAs 114. Thus, for example, each filter 116 and/or 118 can relate to a certain frequency band within which the RF front end 104 can transmit or receive signals.

In an aspect, LNA 124 (and/or 154) can amplify a received signal at a desired output level. In an aspect, each of one or more LNAs 124 may have a specified minimum and maximum gain values for amplifying the received signals. In an aspect, RF front end 104 may use one or more switches to select a particular filter 118 path to an LNA 124. For example, the RF front end 104 may utilize a particular filter 118/LNA 124 based on the specified gain value of the LNA 124 and/or a desired gain value for a particular application.

Further, for example, one or more PA(s) 114 may be used by RF front end 104 to amplify a signal for an RF output transmission at a desired output power level. In an aspect, each PA 114 may similarly have a specified minimum and maximum gain values. In an aspect, RF front end 104 may use one or more switches to select a particular filter 116 path and an associated PA 114 to achieve a desired gain value for a particular application based on the gain value of the PA 114.

Transceiver 106 may be configured to transmit and receive wireless signals through the transmitter antenna 102 and receiver antenna 103, respectively, (and/or other antennas) via RF front end 104. In an aspect, transceiver 106 may be tuned to operate at specified frequencies such that UE 101 can communicate with, for example, network entity 170 at a certain frequency. In an aspect, the one or more processors 105, and/or other processors of UE 101, may configure transceiver 106 to operate at a specified frequency and power level based on the UE configuration of the UE 101 and/or a communication protocol.

In an aspect, transceiver 106 can operate in multiple bands (e.g., using a multiband-multimode modem, not shown) such to process digital data sent and received using transceiver 106. In an aspect, transceiver 106 can be multiband and can be configured to support multiple frequency bands for a specific communications protocol. In an aspect, transceiver 106 can be configured to support multiple operating networks and communications protocols. Thus, for example, transceiver 106 may enable transmission and/or reception of signals from the network based on a specified modem configuration. In an aspect, configuration of the transceiver 106 in this regard can be based on UE configuration information associated with UE 101 as provided by the network during cell selection and/or cell reselection.

In some aspects, UE 101 may also be referred to by those skilled in the art (as well as interchangeably herein) as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a terminal, a user agent, a mobile client, a client, or some other suitable terminology. A UE 101 may be a cellular phone, a personal digital assistant (PDA), a wireless modem, a wireless communication device, a handheld device, a tablet computer, a laptop computer, a cordless phone, a wireless local loop (WLL) station, a global positioning system (GPS) device, a multimedia device, a video device, a digital audio player (e.g., MP3 player), a camera, a game console, a wearable computing device (e.g., a smart-watch, smart-glasses, a health or fitness tracker, etc), an appliance, a sensor, a vehicle communication system, a medical device, a vending machine, or any other similar functioning device.

It is to be appreciated, in an aspect, other devices in the wireless communication system 100, such as network entity 170, can include and implement cancellation signal generator 140. For instance, network entity 170 can be configured to perform analog interference cancellation at an RF front end using DAC 122, as described herein.

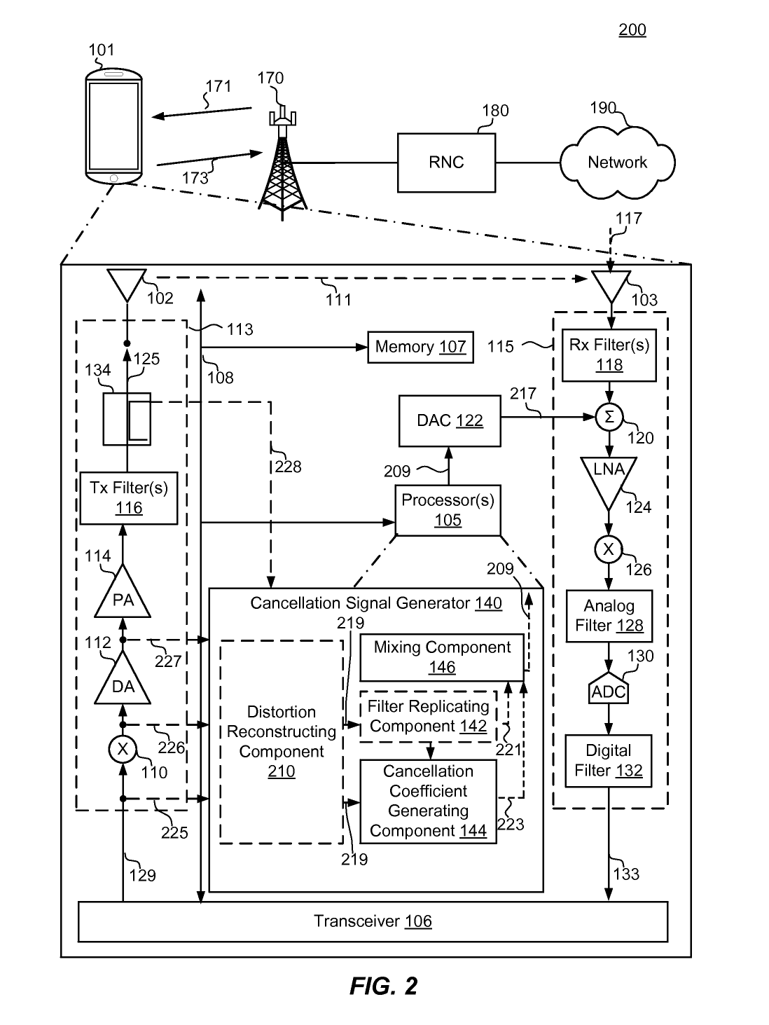

FIG. 2 illustrates a wireless communication system 200 including a UE 101 in communication coverage of a network entity 170 (e.g., a base station or node B (NodeB or NB) providing one or more cells). Wireless communication system 200 can be similar to wireless communication system 100 described above, where the UE 101 includes an RF front end 104 for operating at least a transmitter antenna 102 and a receiver antenna 103 such to transmit transmitted aggressor signal 111 and/or receive signals 117 in a wireless network. In wireless communication system 200, cancellation signal generator 140 of UE 101 may optionally include a distortion reconstructing component 210 as well. In an aspect, for example, distortion reconstructing component 210 may include hardware (e.g., one or more processor modules of the one or more processors 105) and/or computer-readable code or instructions stored in memory 107 and executable by at least one of the one or more processors 105 to perform the specially configured distortion reconstructing operations described herein. RF front end 104 may not include an auxiliary receiver 150, in this example, and cancellation signal generator 140 may tap the aggressor signal 129 to be transmitted from one or more stages of the transmitter chain 113 (e.g., at an input to mixer 110, an output of mixer 110, an output of DA 112, an output of Tx filter 116 via a directional coupler 134, as depicted, or otherwise, etc.), which can include one or more of aggressor signals 225, 226, 227, 228. It is to be appreciated that aggressor signals 225, 226, 227 may be converted to analog (e.g., via respective DACs, not shown) before or upon being provided to the distortion reconstructing component 210.

In this example, aggressor signal 228 tapped from the transmitter chain 113, however, may not include distortion that may be caused to the signal by one or more other components of the RF front end 104 or other environmental factors when transmitting transmitted aggressor signal 111, which can ultimately be the signal received by receiver antenna 103. Accordingly, for example, distortion reconstructing component 210 can reconstruct distortion for adding to the aggressor signal 228 based at least in part on tapping one or more aggressor signals 225, 226, 227 from the transmitter chain 113, and comparing one or more of the aggressor signals 225, 226, 227 to determine distortion caused in transferring the signal among the various components of the transmitter chain 113. Reconstructing the distortion in this regard can allow for generating a more accurate digital cancellation signal 209 for converting to analog cancellation signal 217 via DAC 122.

For example, distortion reconstructing component 210 can reconstruct the distortion to the aggressor signal 228 that may be caused in generating aggressor signal 125 and/or transmitting transmitted aggressor signal 111, and can add the distortion to the aggressor signal 228 to generate a digital representation 219 of the aggressor signal signal 228 plus distortion. Distortion reconstructing component 210 can then pass the resulting digital representation 219 to optional filter replicating component 142 for generating a filtered digital representation 221 and/or to cancellation coefficient generating component 144 for generating cancellation coefficients 223, as described previously and further herein. Mixing component 146 can receive and mix the digital representation 219 or the filtered digital representation 221 with the cancellation coefficients 223 to generate a digital cancellation signal 209 for providing to DAC 122. DAC 122 can convert the digital cancellation signal 209 into an analog cancellation signal 217, which is injected into the receiver chain 115 to cancel interference from transmitted aggressor signal 111 caused to one or more victim signals 117.

FIG. 3 illustrates a method 300 for generating analog cancellation signal 127 for injecting (e.g., adding) into receiver chain 115 of UE 101 to cancel interference to a received signal (e.g., victim signal 117) from one or more signals (e.g., transmitted aggressor signal 111) from transmitter chain 113. Method 300 includes, at Block 302, obtaining an aggressor signal from a transmitter chain of an RF front end. Cancellation signal generator 140 can obtain the aggressor signal from the transmitter chain 113 of the RF front end 104. Obtaining the aggressor signal at Block 302 can optionally include, at Block 304, receiving the aggressor signal using an auxiliary receiver. Thus, for example, cancellation signal generator 140 can receive the aggressor signal 125 using auxiliary receiver 150. For example, switch 152 can be operated to allow auxiliary receiver 150 to receive the aggressor signal 125 from the output of Tx filter 116 (e.g., via directional coupler 134), which may be based on activation of one or more components of the transmitter chain 113 or receiver chain 115, as described. In another example (not shown), auxiliary receiver 150 may be correlated with another antenna that can receive the transmitted aggressor signal 111 transmitted by transmitter antenna 102. In another example, obtaining the aggressor signal at Block 302 may optionally include, at Block 306, obtaining the aggressor signal from one or more components of the transmitter chain. Cancellation signal generator 140 can obtain the aggressor signal 228 from one or more components of the transmitter chain 113, such as by tapping the signal from output of Tx filter 116 via directional coupler 134 or otherwise, etc.

Method 300 also includes, at Block 308, generating a digital representation of the aggressor signal. This may optionally include, at Block 310, performing an analog-to-digital conversion on the aggressor signal as received by the auxiliary receiver. In one example, an ADC 160 of the auxiliary receiver 150 can perform the analog-to-digital conversion on the aggressor signal 125 as received by the auxiliary receiver 150 to generate the digital representation 119 of the aggressor signal 125. As described, this digital representation 119 can include distortion for the signal as received in the aggressor signal 125 by auxiliary receiver 150.

In another example, generating the digital representation at Block 308 may optionally include, at Block 312, digitally reconstructing distortion in the aggressor signal obtained from the transmitter chain. Distortion reconstructing component 210 can digitally reconstruct distortion in the aggressor signal(s) 225, 226, 227 obtained from the transmitter chain 113 (e.g., where the UE 101 does not use an auxiliary receiver 150 to receive the aggressor signal). In one example, distortion reconstructing component 210 can observe distortion in the RF front end 104 (e.g., via receiver antenna 103 and/or one or more components of the receiver chain), and can convert the distortion to a digital reconstruction of the distortion for applying to the aggressor signal 228 to generate the digital representation 219. For example, distortion reconstructing component 210 can obtain one or more aggressor signals 225, 226, 227, and can compare the signals to determine distortion generated in the signal at each transition to mixer 110, DA 112, etc., where the distortion may be determined by determining a mathematical difference of the analog version of the signal as received before and after the transition (e.g., a difference between signals 225 and 226, a difference between signals 226 and 227, etc.). In any case, distortion reconstructing component 210 may reconstruct the distortion determined for the aggressor signals 225, 226, 227, and may convert the distortion into digital form for adding to the aggressor signal 228 to generate digital representation 219 of the aggressor signal 228 plus the distortion for providing to filter replicating component 142 and/or cancellation coefficient generating component 144.

Method 300 may optionally include, at Block 314, replicating a receiver filter for filtering the digital representation of the aggressor signal to a receiver baseband. Filter replicating component 142 can replicate the receiver filter (e.g., Rx filter 118) for filtering the digital representation 119 or 219 of the aggressor signal to the receiver baseband. In this regard, for example, filter replicating component 142 can apply the replicated filter to generate a portion of the digital representation 119, 219 that may actually interfere with the baseband of signals received over the receiver antenna 103. For example, filter replicating component 142 can perform an inverse transform on the digital representation 119, 219 according to the replicated receiver filter such to provide fine attenuation in generating the respective filtered digital representation 121, 221 based on limiting the digital representation 119, 219 to the baseband of the receiver.

Method 300 may also include, at Block 316, estimating cancellation coefficients for the digital representation of the aggressor signal. Cancellation coefficient generating component 144 can estimate the cancellation coefficients 123, 223 for the digital representation 119, 219 of the aggressor signal 125 or aggressor signal 228. For example, cancellation coefficient generating component 144 can estimate the cancellation coefficients 123, 223 associated with a channel of the digital representation 119, 219 as limited to the receiver baseband by the replicated receiver filter. In an example, cancellation coefficient generating component 144 can generate the cancellation coefficients 123, 223 to represent over-the-air distortion caused to aggressor signal 125 that results in transmitted aggressor signal 111 (e.g., based on the aggressor signal 125 received by auxiliary receiver 150). In another example, cancellation coefficient generating component 144 can generate the cancellation coefficients to represent receiver distortion (e.g., based on the filtered digital representation 221 from filter replicating component 142). In another example, cancellation coefficient generating component 144 can generate the cancellation coefficients to represent transmitter distortion (e.g., based on the digitally reconstructed distortion from distortion reconstructing component 210). In one example, cancellation coefficient generating component 144 can generate the cancellation coefficients to minimize |x−w*r|², where x can be the signal received from receiver filter 118, w can be the cancellation coefficient generated by cancellation coefficient generating component 144, and r can be the signal received from directional coupler 134.

Method 300 may also include, at Block 318, generating an analog cancellation signal based at least in part on the cancellation coefficients and the digital representation of the aggressor signal. Cancellation signal generator 140 can utilize DAC 122 to generate the analog cancellation signal 127, 217 based at least in part on the cancellation coefficients 123, 223 and the digital representation 119, 219 of the aggressor signal 125 and/or aggressor signal 228. In one example, this can also optionally include, at Block 320, mixing the cancellation coefficients 123, 223 with the digital representation 119, 219 of the aggressor signal 125 and/or aggressor signal 228. Mixing component 146 can mix the cancellation coefficients 123, 223 with the digital representation 119, 219 of the aggressor signal 125 and/or aggressor signal 228 to generate a digital cancellation signal 109, 209. Cancellation signal generator 140 can provide the digital cancellation signal 109, 209 to DAC 122, which can convert the digital cancellation signal 109, 209 to an analog cancellation signal 127, 217, as described herein.

Method 300 also includes, at Block 322, adding the analog cancellation signal to a victim signal in a receiver chain of the RF front end to cancel interference to the victim signal from the aggressor signal. Summer 120 can add the analog cancellation signal 127, 217, as received from DAC 122, to the victim signal 117 in the receiver chain 115 of the RF front end 104 to cancel interference to the victim signal 117 from the transmitted aggressor signal 111. For example, DAC 122 can pass the analog cancellation signal 127, 217 from cancellation signal generator 140 into a summer 120 for adding to the victim signal 117 received via Rx filter 118. Summing the signals by summer 120 can effectively cancel interference from the transmitted aggressor signal 111 by combining the victim signal 117 received at the Rx filter 118 with the analog cancellation signal 127, 217 generated based on the aggressor signal 125 and/or aggressor signal 228 by cancellation signal generator 140, as described above.

DAC 122 can be an RF DAC, for example. Thus, as shown in FIG. 4, generating the analog cancellation signal at Block 318 may optionally include, at Block 402, generating the analog cancellation signal using an RF DAC. The RF DAC can include a band-pass sigma-delta filter, a pulse width modulator, a switched capacitors digital polar DAC, a combination thereof, and/or the like, to provide a low cost digital-to-analog conversion of the analog cancellation signal 127, 217. Thus, as shown in FIG. 4, generating the analog cancellation signal at Block 318 may optionally include, at Block 404, generating the analog cancellation signal using an RF DAC comprising a band-pass sigma-delta filter. In this regard, for example, DAC 122 may include a band-pass sigma-delta DAC, as described.

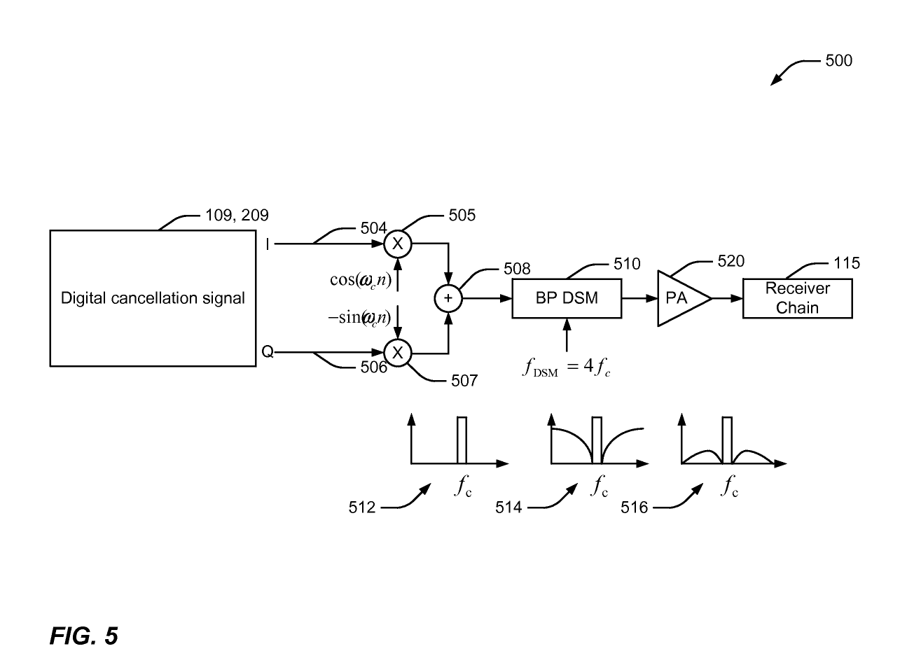

FIG. 5 illustrates an example band-pass sigma-delta filter 500. For example, the digital cancellation signal 109 or 209, generated by cancellation signal generator 140, can be separated into in-phase (I) 504 and quadrature-phase (Q) 506 branch signals for modulating on carriers by modulators 505, 507, where the resulting signals can be combined by a combiner 508. The resulting signal is passed to a band-pass delta-sigma modulator (BP DSM) 510 for oversampling the signal (e.g., the signal f_{DSM}=4f_{c}) to remove spectral quantization noise. The resulting signal may be similar to one or more of the signals 512, 514, 516, which are represented as frequency on the horizontal axis by time on the vertical axis, to produce signal f_{c}. This can produce multi-tap coefficients in the signal, which can then be passed to a PA 520 for amplifying the power of the signal. Thus, for example, band-pass sigma-delta filter 500 can generate multiple signal components of the aggressor signal mixed with the cancellation coefficients and BP DSM 510 can modulate the multiple signal components using band-pass sigma-delta modulation. The resulting signal, which can be analog cancellation signal 127, 217, can be passed to a receiver chain 115 for injecting to cancel interference from the aggressor signal. As described, for example, the signal can be injected into a summer 120 for adding to a signal received at a Rx filter 118 in the receiver chain (FIG. 1). The band-pass sigma-delta filter 500 provides high efficiency in power and linearity, for example.

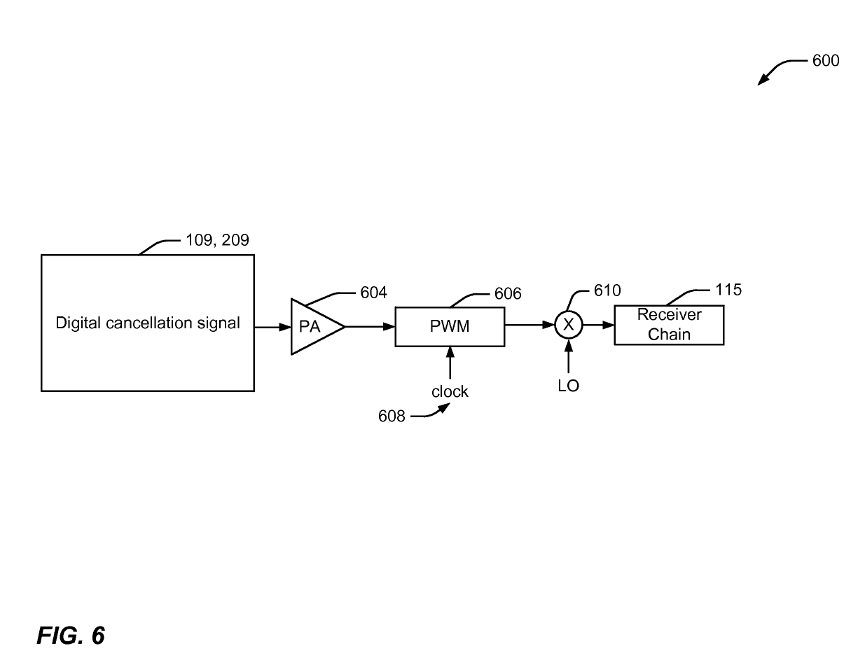

Referring again to FIG. 4, generating the analog cancellation signal at Block 318 may optionally include, at Block 406, generating the analog cancellation signal using an RF DAC comprising a pulse width modulator. Thus, as described, DAC 122 may include a pulse width modulator. FIG. 6 illustrates an example pulse width modulator 600. For example, digital cancellation signal 109, 209, generated by cancellation signal generator 140, can be passed to a PA 604 for amplifying a power thereof, and then to a pulse width modulator (PWM) 606. The PWM 606 can generate an analog signal from the signal passed from PA 604 by using pulse-width modulation based on a clock signal 608. For example, PWM 606 can obtain different widths of samples of the aggressor signal mixed with the cancellation coefficients, and can modulate the different widths of samples based on the clock signal 608. The resulting analog signal can be passed to a mixer 610 for mixing with a local oscillator (LO) to convert the signal to a frequency related to a receiver. The signal, which can be analog cancellation signal 127, 217, can then be injected into the receiver chain 115 for cancelling interference caused by the aggressor signal. As described, for example, the signal can be injected into a summer 120 for adding to a signal received at a Rx filter 118 in the receiver chain (FIG. 1). The pulse width modulator 600 provides high efficiency in power and linearity, for example, and can be sufficient for driving slow varying coefficients of the interfering aggressor signal.

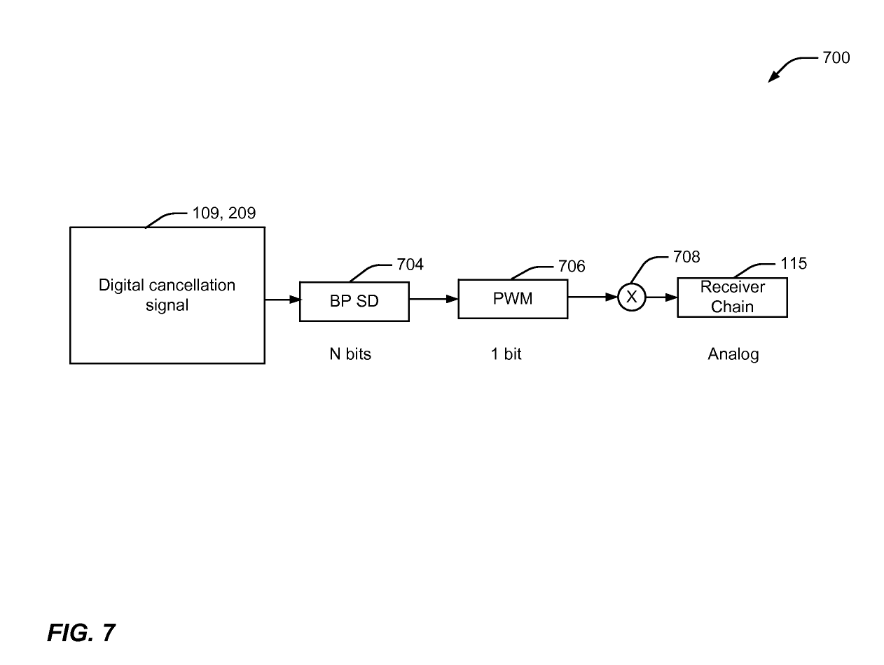

Referring again to FIG. 4, generating the analog cancellation signal at Block 318 may optionally include, at Block 408, generating the analog cancellation signal using an RF DAC comprising a band-pass sigma-delta filter and a pulse width modulator. FIG. 7 illustrates an example band-pass sigma-delta filter and pulse width modulator 700. For example, digital cancellation signal 109, 209, generated by cancellation signal generator 140, can be passed, as a number (N) of bits, to a band-pass sigma-delta filter (BP SDF) 704, which can be similar to at least a portion of band-pass sigma-delta filter 500 in FIG. 5. For example, BP SDF 704 can include one or more of modulators 505, 507, combiner 508, BP DSM 510, PA 520, etc. The signal generated by BP SDF 704 can be passed, one bit at a time for generating an analog signal, to the PWM 706, which may be similar to PWM 606 of FIG. 6, as described. The resulting analog signal can be passed to a mixer 708 for mixing with a local oscillator (LO) to convert the signal to a frequency related to a receiver. The signal, which can be analog cancellation signal 127, 217, can then be injected into the receiver chain 115 for cancelling interference caused by the aggressor signal. As described, for example, the signal can be injected into a summer 120 for adding to a signal received at a Rx filter 118 in the receiver chain (FIG. 1).

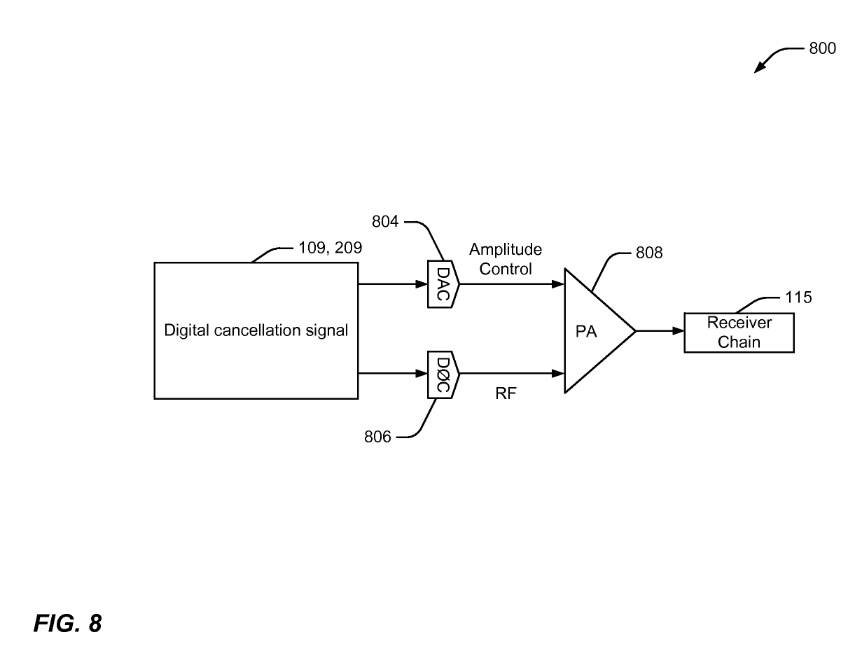

Referring again to FIG. 4, generating the analog cancellation signal at Block 318 may optionally include, at Block 410, generating the analog cancellation signal using an RF DAC comprising a digital polar DAC. For example, the digital polar DAC may include a switched capacitors digital polar DAC. FIG. 8 illustrates an example digital polar DAC 800. For example, the digital cancellation signal 109 or 209, generated by cancellation signal generator 140, can be passed to both a DAC 804 and a digital-to-RF phase converter (DØC) 806. The signal from the DØC 806 can be the RF signal, and the signal from the DAC 804 can provide amplitude control for the signal. Both signals output from DAC 804 and DØC 806 can be provided to a PA 808 for amplifying the power of the signal. The resulting signal, which can be analog cancellation signal 127, 217, can be passed to a receiver chain 115 for injecting to cancel interference from the aggressor signal. As described, for example, the signal can be injected into a summer 120 for adding to a signal received at a Rx filter 118 in the receiver chain (FIG. 1). In yet another example, the RF DAC may include the switched capacitors digital polar DAC along with the band-pass sigma-delta DAC and/or pulse width modulator, etc.

Several aspects of a telecommunications system have been presented with reference to a W-CDMA system. As those skilled in the art will readily appreciate, various aspects described herein may be extended to other telecommunication systems, network architectures and communication standards.

By way of example, various aspects described herein may be extended to other UMTS systems such as W-CDMA, TD-SCDMA, High Speed Downlink Packet Access (HSDPA), High Speed Uplink Packet Access (HSUPA), High Speed Packet Access Plus (HSPA+) and TD-CDMA. Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

In accordance with various aspects described herein, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described herein. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. The computer-readable medium may be a non-transitory computer-readable medium. A non-transitory computer-readable medium includes, by way of example, a magnetic storage device (e.g., hard disk, floppy disk, magnetic strip), an optical disk (e.g., compact disk (CD), digital versatile disk (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, a removable disk, and any other suitable medium for storing software and/or instructions that may be accessed and read by a computer. The computer-readable medium may also include, by way of example, a carrier wave, a transmission line, and any other suitable medium for transmitting software and/or instructions that may be accessed and read by a computer. The computer-readable medium may be resident in the processing system, external to the processing system, or distributed across multiple entities including the processing system. The computer-readable medium may be embodied in a computer-program product. By way of example, a computer-program product may include a computer-readable medium in packaging materials. Those skilled in the art will recognize how best to implement the functionality described herein depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods or methodologies described herein may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described herein that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112(f) unless the element is expressly recited using the phrase “means for” or, in the case of a method claim, the element is recited using the phrase “step for.”

1. A method for providing analog interference cancellation using digitally computed coefficients, comprising:
obtaining an aggressor signal from a transmitter chain of a radio frequency (RF) front end;
generating a digital representation of the aggressor signal;
estimating, by a processor, cancellation coefficients for the digital representation of the aggressor signal;
utilizing a digital polar digital-to-analog converter (DAC) to generate an analog cancellation signal based at least in part the cancellation coefficients and the digital representation of the aggressor signal; and
adding the analog cancellation signal to a victim signal in a receiver chain of the RF front end to cancel interference to the victim signal from the aggressor signal.

2. The method of claim 1, wherein obtaining the aggressor signal comprises receiving the aggressor signal at an auxiliary receiver, and wherein generating the digital representation of the aggressor signal comprises performing an analog-to-digital conversion on the aggressor signal to generate the digital representation of the aggressor signal.

3. The method of claim 1, wherein obtaining the aggressor signal comprises obtaining the aggressor signal from at least one of a mixer, one or more amplifiers, and/or a transmit filter in the transmitter chain, and wherein generating the digital representation of the aggressor signal comprises digitally reconstructing distortion in the aggressor signal obtained from the transmitter chain.

4-8. (canceled)

9. The method of claim 1, further comprising replicating a receiver filter for filtering the digital representation of the aggressor signal to a receiver baseband, wherein the digital polar DAC generates the analog cancellation signal based in part on the digital representation of the aggressor signal as filtered to the receiver baseband.

10. An apparatus for providing analog interference cancellation using digitally computed coefficients, comprising:
a transmitter antenna coupled to one or more components of a transmitter chain of a radio frequency (RF) front end configured to transmit an aggressor signal;
a receiver antenna coupled to one or more components of a receiver chain of the RF front end configured to receive a victim signal and the aggressor signal;
at least one processor communicatively coupled with the transmitter chain and the receiver chain and having a cancellation signal generator executable by the at least one processor to:
obtain the aggressor signal from the transmitter chain of the RF front end;
generate a digital representation of the aggressor signal; and
estimate cancellation coefficients for the digital representation of the aggressor signal;
a digital polar digital-to-analog converter (DAC) configured to:
generate an analog cancellation signal based at least in part the cancellation coefficients and the digital representation of the aggressor signal; and
a summer configured to:
add the analog cancellation signal received from the DAC to the victim signal in the receiver chain of the RF front end to cancel interference to the victim signal from the aggressor signal.

11. The apparatus of claim 10, wherein the cancellation signal generator is executable to obtain the aggressor signal at least in part by receiving the aggressor signal at an auxiliary receiver and to generate the digital representation of the aggressor signal at least in part by performing an analog-to-digital conversion on the aggressor signal to generate the digital representation of the aggressor signal.

12. The apparatus of claim 10, wherein the cancellation signal generator is executable to obtain the aggressor signal at least in part by obtaining the aggressor signal from at least one of a mixer, one or more amplifiers, and/or a transmit filter in the transmitter chain and further comprising a distortion reconstructing component to generate the digital representation of the aggressor signal at least in part by digitally reconstructing distortion in the aggressor signal obtained from the transmitter chain.

13-16. (canceled)

17. The apparatus of claim 10, wherein the cancellation signal generator further includes a filter replicating component executable to replicate a receiver filter for filtering the digital representation of the aggressor signal to a receiver baseband, wherein the digital polar DAC is executable to generate the analog cancellation signal based in part on the digital representation of the aggressor signal as filtered to the receiver baseband.

18. An apparatus for providing analog interference cancellation using digitally computed coefficients, comprising:
means for obtaining an aggressor signal from a transmitter chain of a radio frequency (RF) front end;
means for generating a digital representation of the aggressor signal;
means for estimating cancellation coefficients for the digital representation of the aggressor signal;
means for utilizing a digital polar digital-to-analog converter (DAC) to generate an analog cancellation signal based at least in part the cancellation coefficients and the digital representation of the aggressor signal; and
means for adding the analog cancellation signal to a victim signal in a receiver chain of the RF front end to cancel interference to the victim signal from the aggressor signal.

19. The apparatus of claim 18, wherein the means for obtaining the aggressor signal receives the aggressor signal at an auxiliary receiver, and wherein the means for generating the digital representation of the aggressor signal performs an analog-to-digital conversion on the aggressor signal to generate the digital representation of the aggressor signal.

20. The apparatus of claim 18, wherein the means for obtaining the aggressor signal comprises obtains the aggressor signal from at least one of a mixer, one or more amplifiers, and/or a transmit filter in the transmitter chain, and wherein the means for generating the digital representation of the aggressor signal digitally reconstructs distortion in the aggressor signal obtained from the transmitter chain.

21-24. (canceled)

25. A non-transitory computer-readable medium comprising code executable by a computer for providing analog interference cancellation using digitally computed coefficients, the code comprising:
code for obtaining an aggressor signal from a transmitter chain of a radio frequency (RF) front end;
code for generating a digital representation of the aggressor signal;
code for estimating cancellation coefficients for the digital representation of the aggressor signal;
code for utilizing a digital polar digital-to-analog converter (DAC) to generate an analog cancellation signal based at least in part the cancellation coefficients and the digital representation of the aggressor signal; and
code for adding the analog cancellation signal to a victim signal in a receiver chain of the RF front end to cancel interference to the victim signal from the aggressor signal.

26. The non-transitory computer-readable medium of claim 25, wherein the code for obtaining the aggressor signal receives the aggressor signal at an auxiliary receiver, and wherein the code for generating the digital representation of the aggressor signal performs an analog-to-digital conversion on the aggressor signal to generate the digital representation of the aggressor signal.

27. The non-transitory computer-readable medium of claim 25, wherein the code for obtaining the aggressor signal comprises obtains the aggressor signal from at least one of a mixer, one or more amplifiers, and/or a transmit filter in the transmitter chain, and wherein the code for generating the digital representation of the aggressor signal digitally reconstructs distortion in the aggressor signal obtained from the transmitter chain.

28-30. (canceled)

31. The method of claim 1, wherein the digital polar DAC comprises a DAC, a digital-to-RF phase converter (DØC), and a power amplifier, and wherein utilizing the digital polar DAC to generate the analog cancellation signal comprises:
providing a digital cancellation signal to the DAC to obtain an amplitude control for the digital cancellation signal;
providing the digital cancellation signal to the DØC to obtain an RF signal corresponding to the digital cancellation signal; and
providing the amplitude control and the RF signal to the power amplifier to generate the analog cancellation signal.

32. The method of claim 31, wherein the digital cancellation signal corresponds to the cancellation coefficients and the digital representation of the aggressor signal.

33. The method of claim 31, wherein the digital polar DAC includes a switched capacitors digital polar DAC.

34. The method of claim 31, wherein the DAC is at least one of a band-pass sigma-delta DAC or a pulse width modulator.

35. The apparatus of claim 10, wherein the digital polar DAC comprises a DAC, a digital-to-RF phase converter (DØC), and a power amplifier, and wherein the digital polar DAC is further configured to:
provide a digital cancellation signal to the DAC to obtain an amplitude control for the digital cancellation signal;
provide the digital cancellation signal to the DØC to obtain an RF signal corresponding to the digital cancellation signal; and
provide the amplitude control and the RF signal to the power amplifier to generate the analog cancellation signal.

36. The apparatus of claim 35, wherein the digital cancellation signal corresponds to the cancellation coefficients and the digital representation of the aggressor signal.

37. The apparatus of claim 35, wherein the digital polar DAC includes a switched capacitors digital polar DAC.

38. The apparatus of claim 35, wherein the DAC is at least one of a band-pass sigma-delta DAC or a pulse width modulator.

39. The apparatus of claim 18, wherein the digital polar DAC comprises a DAC, a digital-to-RF phase converter (DØC), and a power amplifier, and wherein the means for utilizing the digital polar DAC utilizes the digital polar DAC to:
provide a digital cancellation signal to the DAC to obtain an amplitude control for the digital cancellation signal;
provide the digital cancellation signal to the DØC to obtain an RF signal corresponding to the digital cancellation signal; and
provide the amplitude control and the RF signal to the power amplifier to generate the analog cancellation signal.

40. The apparatus of claim 39, wherein the digital polar DAC includes a switched capacitors digital polar DAC.

41. The apparatus of claim 39, wherein the DAC is at least one of a band-pass sigma-delta DAC or a pulse width modulator.

42. The apparatus of claim 18, further comprising means for replicating a receiver filter for filtering the digital representation of the aggressor signal to a receiver baseband, wherein the means for utilizing the digital polar DAC utilizes the digital polar DAC to generate the analog cancellation signal based in part on the digital representation of the aggressor signal as filtered to the receiver baseband.

43. The non-transitory computer-readable medium of claim 25, wherein the digital polar DAC comprises a DAC, a digital-to-RF phase converter (DØC), and a power amplifier, and wherein the code for utilizing the digital polar DAC utilizes the digital polar DAC to:
provide a digital cancellation signal to the DAC to obtain an amplitude control for the digital cancellation signal;
provide the digital cancellation signal to the DØC to obtain an RF signal corresponding to the digital cancellation signal; and
provide the amplitude control and the RF signal to the power amplifier to generate the analog cancellation signal.

44. The non-transitory computer-readable medium of claim 43, wherein the digital polar DAC includes a switched capacitors digital polar DAC.

45. The non-transitory computer-readable medium of claim 43, wherein the DAC is at least one of a band-pass sigma-delta DAC or a pulse width modulator.

46. The non-transitory computer-readable medium of claim 25, further comprising code for replicating a receiver filter for filtering the digital representation of the aggressor signal to a receiver baseband, wherein the code for utilizing the digital polar DAC utilizes the digital polar DAC to generate the analog cancellation signal based in part on the digital representation of the aggressor signal as filtered to the receiver baseband.
